(19) United States
(12) Patent Application Publication
(10) Pub. No.: US 2008/0133339 A1
(43) Pub. Date: Jun. 5, 2008

(54) Apparatus and method for reward points issuance, accumulation management and redemption using product coded wireless, communication protocols

(75) Inventors: Niko Drakoulis, Arlington Heights, IL (US); John Karantonis, Chicago, IL (US); Georgios Stoikos, Serres (GR)

Correspondence Address: YOUNG & BASILE, P.C., 3001 WEST BIG BEAVER ROAD, SUITE 624, TROY, MI, 48084, US

(73) Assignee: Akoo International, Inc., Elmwood Park, IL (US)

(21) Appl. No.: 11/337,452

(22) Filed: Jan. 23, 2006

(51) Int. Cl. G06Q 30/00

(52) U.S. Cl. 705/14

(57) ABSTRACT

A method and apparatus for operating a reward points issuance, accumulation management and redemption program in which a wireless device user accumulates reward points by messaging a reward code to a wireless communications gateway associated with a plurality of independent product entities or location-based proximity services. Earned reward points are tracked in a user reward point account stored on a rewards server. A dedicated account server accumulates some or all of a customer's earned reward points from the reward servers and credits the accumulated points into a single reward redemption account associated with the customer. The customer may then select an item for purchase from the reward points issuing entity or redeem credits for access to a plurality of services with the accumulated reward points.

### BACKGROUND

The present invention relates, in general, to customer reward programs.

Customer reward or loyalty programs are widely used by businesses to obtain new clients as well as to retain existing clients. Rewards or points are accumulated for each purchase of a particular product or service from a company. Airline frequent flyer miles are an example of one of the most popular loyalty programs.

In many of the existing customer reward programs, the product or service of purchase transaction is electronic based and is triggered when the customer uses a loyalty card, credit card, debit card, or in the case of telephone or cellular phone loyalty programs, makes a call using his or her phone.

However, in many instances the customer purchases a product or service in a non-electronic transaction. Such transactions are not usually captured by the existing customer reward or loyalty programs.

Mobile wireless communication through the use of cellular phones, PDAs, portable laptop computers, etc. is becoming the most prevalent forms of electronic data communication throughout the world. Electronic mail and communication using text messages via a Short Message Service (SMS) are widely used to transmit and receive electronic messages in a mobile environment.

It would be desirable to take advantage of the ever-increasing availability of wireless communications to trigger a customer loyalty or reward program transaction.

### SUMMARY OF THE INVENTION

A method and apparatus for operating a wireless reward points issuance, accumulation and redemption program, at least part of which utilizes wireless communication of input product and service ID codes by a program customer.

In one aspect, a method of operating a wireless data rewards issuance program is disclosed which includes the steps of establishing a central rewards processor controlling the input, authentication and management of reward codes associated with products and services corresponding to incremental accumulation of preset reward points on behalf of at least one reward points issuing entity, transmitting at least part of the input reward codes on a wireless communication gateway including wireless communication from a customer originating device, and verifying the customer ID and product/service ID in each message received by the processor and storing reward points associated with the product ID or service ID according to preset reward program rules in a customer account for one reward point issuing entity.

In another aspect a rewards program apparatus includes discrete product ID and service ID applied to each discrete product and service covered by a reward points program, a central rewards server adapted for receiving customer ID, product ID, and service ID through a communications gateway from a customer device, at least part of the communication gateway including a wireless communication, a business loyalty account server provided for at least one business entity participating in the reward program, an individual customer account of reward points established in at least one of the central rewards server and the business loyalty account server, the central rewards server accumulating individual customer reward points, and at least one of the central rewards server and the business loyalty account server comparing individual customer accumulated points with a reward threshold and allowing redemption of at least some of the reward points when an individual customer accumulated points exceeds a reward point threshold.

### BRIEF DESCRIPTION OF THE DRAWINGS

The various features, advantages and other uses of the present invention will become more apparent by referring to the following detailed description and drawing in which:

FIG. 1 is a block diagram of a reward points issuance, accumulation management and redemption apparatus;

FIG. 2 is a detailed block diagram of the apparatus shown in FIG. 1; and

FIG. 3 is a more detailed block diagram of the apparatus shown in FIG. 2.

DETAILED DESCRIPTION

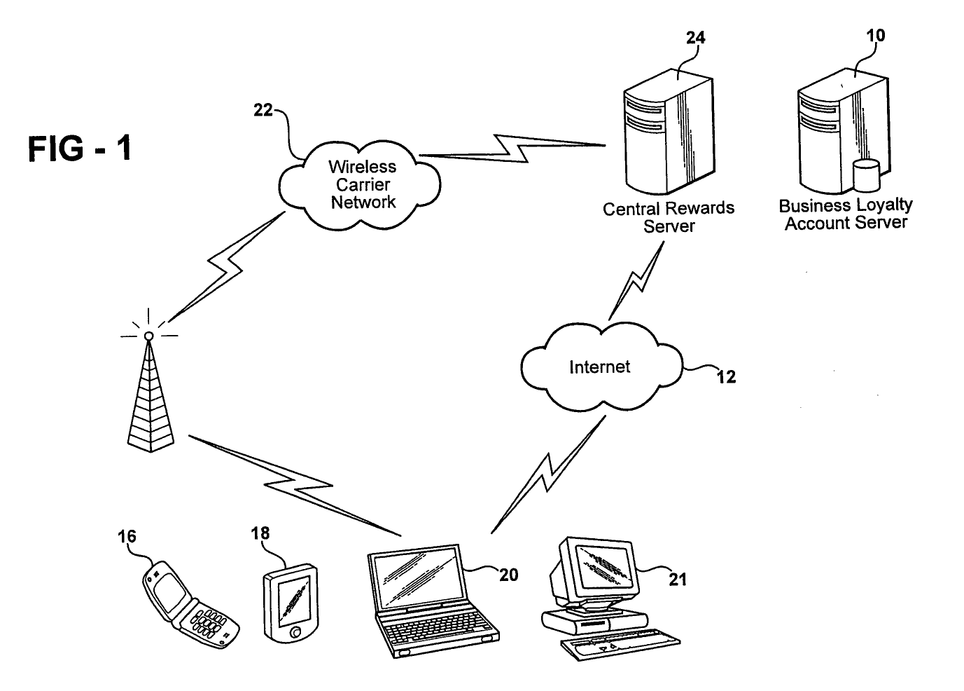

In one aspect shown in FIGS. 1-3, a central management system manages a communication link to mobile stations in a computer network and translates packets in the payloads of SMS, MMS or Internet messages containing specific content created by a mobile user located remote from a central rewards server 24 implemented as a feature of communication link, such as a wireless carrier network 22, which may be implemented as a Short-Message-Service-Center (SMSC) and Mobile-Multimedia-Service-Environment (MMSE) or an Internet network 12, manages concurrent mobile-originating transmissions representing mobile and/or wireless user inputs.

At least a portion of the carrier network 22 may include wireless communication. The central rewards server 24 addresses a host network server via HTTP, for example, that maintains a master set of customer data, product and service ID codes, etc. The server 24 receives mobile input information from the carrier network 22 or the Internet 12.

Specific actions initiated by a mobile user 16, 18, 20 including product and service ID's or a wireless PC 21 are received at the central server 24. The server 24 interfacing the carrier network 22 or the Internet 12 and one or more business loyalty by account servers 10 operates on a scheduled peer session interval to authenticate users, determine the content of the event and handle submission of inputs.

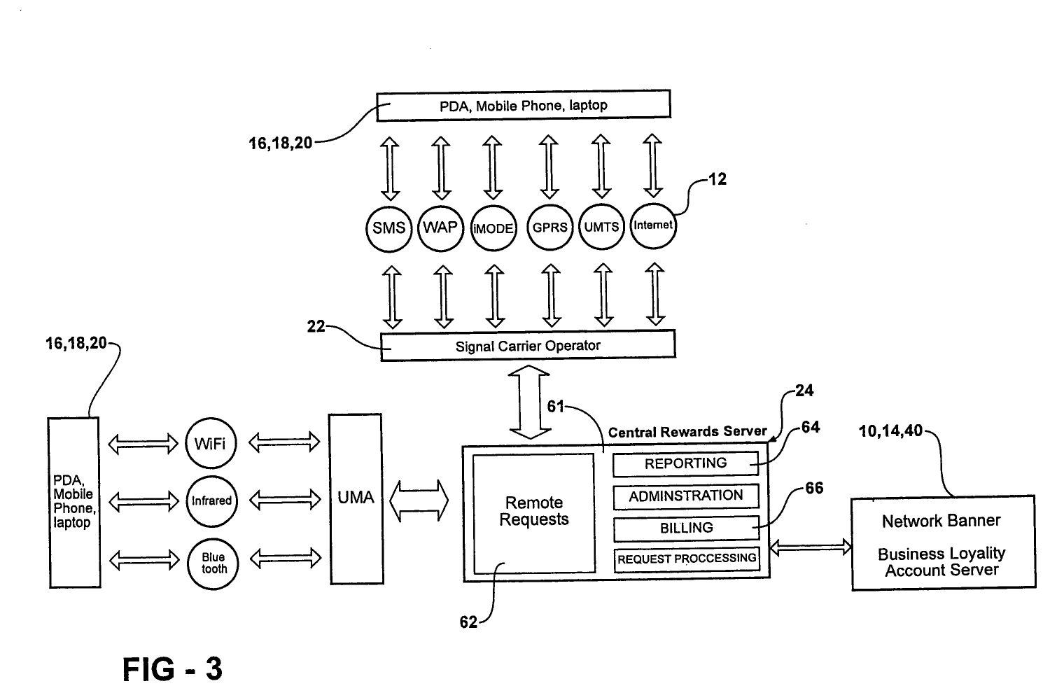

According to one aspect shown in FIG. 3, a mobile communication device or user interface, typically a mobile wireless communication device, such as a cellular telephone 16, a PDA 18, or a computer 20, 21 as non-limiting examples only, communicates with the communication network 22. The communication link or network 22 may be any type of communication provider either wireless or not, such as, but not limited to, WiFi, Internet, direct cable connection, Ethernet, GSM, GRPS, UMTS, EDGE, Token ring etc. Such a network 22 may have as a subset, a Short Message Service Center (SMSC) adapted for short text messaging, an Internet protocol having displayable drop down menus allowing user input selections, or a multimedia service (MMS) providing audio and graphic data.

Although the following example of a wireless content request pertains to a short message service using an SMSC subset of the wireless carrier network 22, it will be understood that similar data input protocols or media selection, such as through drop down menus, may also be employed.

Before continuing of the description of the communication network, it will be understood that the loyalty program requires that each individual product or service event be provided with a unique ID or identifier. Thus, in the case of multiple products sold in a package, such as a six pack of beverages, each individual beverage container in the six pack will carry a unique product identifier. Any suitable identification protocol can be employed, such as a 128 bit, alphanumeric character. The product identifier can be printed directly on the container or applied to the container by other suitable means, such as stick-on label, etc. Each individual product or service event may also include the SMS address for the customer to input the product or service ID. Alternately, the SMS address for the product or service ID input may be provided to the customer by separate means, such as in a separate SMS message, advertising, etc.

It will also be understood that the SMS address, which would typically include a large number of alphanumeric characters, may be provided in a short form, such as a four or five digit short form address, similar to the use of short Internet domain names for the full Internet address.

An appropriate SMS address, such as “1414” for example, is entered by the user through the communication device 16, 18, 20, or 22 to identify the loyalty program service. Text messages formed of UNICODE or ASCII characters are then input by a user through the user interface 16, 18, or 20 to identify the product or service ID. For example, a text message of “AB123” can be input by a user through the communication device 16, 18, 20, or 21.

The AB123 ID can identify a particular beverage product and container. In addition, the product or service ID may also be used to distinguish geographic areas, individual stores, etc.

These signals are transmitted to the SMSC where the customer ID is validated. The location of the customer is transmitted from the SMSC to the server 24 by hard wire and/or wireless communication. The server 24 receives the data from the SMSC and communicates with the business loyalty account network servers 10.

Individual customer ID, reward point totals, may be verified, accumulated and stored in the server 24 or, alternately, in each of the business loyalty account servers 10. Each server 10 may, when the reward total for an individual customer exceeds a predetermined threshold qualifying a customer for a reward, communicate the reward information through the server 24 to the customer via an SMS text message. Internet e-mail, etc. The customer can choose to redeem his or her reward points by selecting a particular reward as offered by the reward point issuing entity in return message or after reviewing an online catalog of various rewards which the customer can select based on the size of the reward total and other factors.

The server 24 can also establish an independent reward point account for each of the plurality of servers 10. Each independent reward point account for a customer, and it will be understood that one particular customer may have multiple accounts, one for each different reward point issuing entity is stored as a dedicated reward registration server in the server 24.

The reward point redemption can either be on a specific reward point issuing entity basis wherein the number of points accumulated by a customer for that one particular reward issuing entity enables the customer to collect a reward only from that one entity. Alternately, the server 24 can implement a reward point sharing program wherein reward points accumulated for a particular customer at one issuing reward point entity can be transferred under reward program rules to a different reward point entity for redemption.

The server 24 is also capable of sending a message through the SMSC to the customer thanking the customer for entering the data. This will confirm that the input has been implemented. At the same time, the message to the customer 16 can include other messages, such as an offer to buy additional products or services.

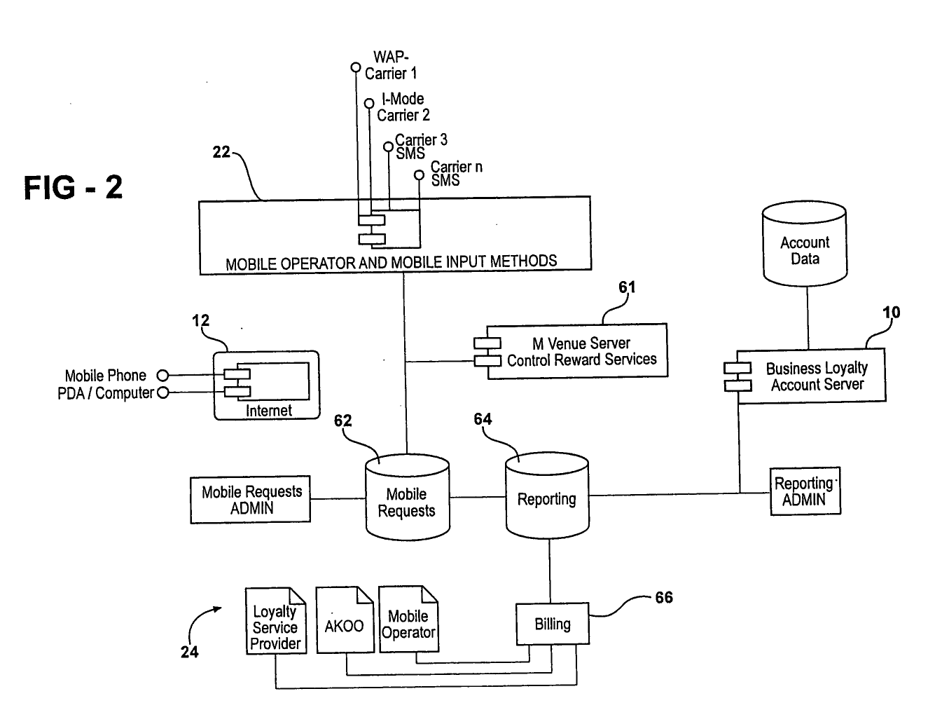

FIGS. 2 and 3 depict block diagrams of the major components of the apparatus. The server 24 includes a so-called m-Venue server 61 which communicates with the business network servers 10.

FIG. 3 also depicts the transmission or communication of digital data signals from the customer interfaces or devices 16, 18, 20, and 21 through the signal carrier network 22 as described above in conjunction with FIG. 1, or through the Internet 12. The server 24, as described above, can receive input data from any source. The server 24 then checks the signal for validity, processes it, stores it in a database, and forwards the data to the network server 10 in the aspect shown in FIG. 1.

1. A method of operating a wireless data reward points issuance, accumulation and redemption program comprising the steps of:
establishing a central rewards processor controlling the input, authentication and management of reward codes associated with products and services corresponding to incremental accumulation of preset reward points on behalf of at least one reward points issuing entity;
transmitting at least part of the input reward codes on a wireless communication gateway including wireless communication from a customer originating device to the communication gateway; and
verifying the customer ID and product/service ID in each message received by the central processor and storing reward points associated with the product ID or service ID according to preset reward program rules in a customer account for one reward point issuing entity.

2. The method of claim 1 transmitting step further comprising the step of:
establishing a short message service protocol for transmitting product and service identifiers from each customer to the central rewards processor.

3. The method of claim 1 further comprising the step of:
applying a discrete product ID and a service ID to each discrete product and service.

4. An apparatus for wireless data reward points issuance, accumulation and redemption, the apparatus comprising:
means for establishing a central rewards processor controlling the input, authentication and management of reward codes associated with products and services corresponding to incremental accumulation of preset reward points on behalf of at least one reward points issuing entity;
means for transmitting at least part of the input reward codes on a wireless communication gateway including wireless communication from a customer originating device to the communication gateway; and
means for verifying the customer ID and product/rewire ID in each message received by the central processor and storing reward points associated with the product ID or service ID according to preset reward program rules in a customer account for one reward point issuing entity.

5. A reward points issuance, accumulation and redemption program apparatus comprising:
discrete product ID and service ID applied to each discrete product and service covered by a reward points program;
a central rewards server adapted for receiving customer ID, product ID, and service ID through a communications gateway from a customer device, at least part of the communication gateway including a wireless communication;
a business loyalty account server provided for at least one business entity participating in the reward program;
an individual customer account of accumulated reward points established in at least one of the central rewards server and the business loyalty account server; and
at least one of the central rewards server and the business loyalty account server comparing individual customer accumulated points with a reward threshold and allowing redemption of at least some of the reward points when an individual customer accumulated reward points exceeds a reward point threshold.
